(19) United States
(12) Patent Application Publication
(10) Pub. No.: US 2014/0026485 A1
(43) Pub. Date: Jan. 30, 2014

(54) Single Layer Gas Processing

(71) Applicants: John JASBINSEK, Ontario, CA (US); Paul G. Katona, Upland, CA (US)

(72) Inventors: John JASBINSEK, Ontario, CA (US); Paul G. Katona, Upland, CA (US)

(73) Assignee: Co2Fuel, LLC, Upland, CA (US)

(21) Appl. No.: 13/557,456

(22) Filed: Jul. 25, 2012

(51) Int. Cl. C01B 3/36; C01B 31/18

(52) U.S. Cl. 48/198.5; 423/418.2

(57) ABSTRACT

A process for converting carbon dioxide (CO2) gas into a medium BTU gas is disclosed. The CO2 gas may be injected into a reactor alone or simultaneously with a hydrocarbon gas and converted into a gas product suitable for further processing. The conversion process may include molten layers of iron and reactive slag in an upwardly flowing reactor operated under oxygen lean conditions.

### FIELD OF THE DISCLOSURE

The disclosure relates to a process for converting of carbon dioxide (CO2) gas that has been separated from industrial flue gases generated from combustion of coal, oil or gases into a clean burning medium BTU gas.

### BACKGROUND

Flue gases generated from combustion of coal, oil, and fuel gases in power production plants contain various amounts of SOx, NOx and carbon dioxide (CO2) that must be cleaned from the discharged gases to meet the clean air requirements. Global climate change concerns have sparked initiatives to reduce CO2 emissions. Thus economic removal of CO2 from gas streams has become increasingly important. Each fossil-fueled power plant in the U.S. exhausts millions of tons of CO2 gas per year. The Energy Department in 2010 awarded $575 million for carbon capture research and development projects in 15 states under the stimulus law. The Energy Department has invested more than $4 billion overall in carbon storage and capture, which was matched by more than $7 billion in private funds. This money will fund approximately 22 projects in 15 states, including California, Pennsylvania, Colorado, New York, and Texas. The projects range from evaluation of geologic sites for carbon storage to development of turbo-machinery and engines to help improve carbon capture and storage.

On Oct. 8, 2009, We Energies Alston and the Electric Power Research Institute (EPRI) announced that a pilot testing an advanced chilled ammonia system demonstrated more than 90% CO2 capture from the flue gas stream at the Pleasant Prairie Power Plant in Wisconsin. The project also achieved key research metrics around hours of operation ammonia release and CO2 purity. Lessons learned at Pleasant Prairie provided critical information for efforts to scale up effective carbon capture and storage technologies for new power plants and to retrofit existing plants.

A scaled-up 20-megawatt (electric) capture system has been installed at American Electric Power's 1,300-megawatt Mountaineer Plant in West Virginia, where it will remove an estimated 90% of CO2 emissions from the flue gas stream it processes, capturing up to 100,000 metric tons of CO2 per year.

Other companies and research institutes in the United States and abroad, such as Exxon Mobil, University of Texas at Austin, Oak Ridge National Laboratory in Oak Ridge, Tenn., the EPA, and Karl Steiger GmbH and Renergiepartner GmbH of Germany report breakthroughs in technologies of removal CO2 from flue gases, transportation, injection and storage. Global climate change concerns have sparked initiatives to reduce CO2 emissions. Thus economic removal of CO2 from gas streams has become increasingly important.

One experimental technique involves storing CO2 emissions from coal plants and other sources underground in an effort to reduce pollution blamed for contributing to global warming. It would be desirable to have a process which would enable the recovered CO2 gas to further process into a medium BTU clean burning gas rather than store it in underground storage.

### SUMMARY

It is an object of the disclosure to provide a process to convert CO2 gas that has been separated from industrial waste gas streams generated from burning coal, oil, or gases in power plants into CO medium BTU fuel gas.

It is another object of the disclosure to provide a process that simultaneously converts CO2 and a hydrocarbon gas into a gas of suitable composition for further processing of liquid fuel. In accordance with this object and others that will become apparent from the description herein, the process according to the disclosure may comprise passing CO2 gas through a layer of molten iron and a layer of reactive slag under conditions comprising a carbon:oxygen (C:O) ratio of greater than one. These conditions may be sufficient to convert CO2 gas into a medium BTU gas product. In at least one embodiment, CO2 gas and a hydrocarbon gas stream is passed through a layer of molten iron and a layer of reactive slag comprising a C:O ratio greater than one, which may be sufficient to produce a synthetic gas (syn-gas) of a composition suitable for synthesis of liquid fuels. The syn-gas may be used for further processing of liquid fuel into low sulfur diesel fuel, gasoline, avionic fuel or any other hydrocarbon product according the Fischer-Tropsch process. Converting CO2 gas into useful medium BTU gas may be economical and efficient.

### BRIEF DESCRIPTION OF THE DRAWINGS

FIG. 1. illustrates a single layer treatment reactor having external induction heating coils in accordance with one or more aspects of the disclosure.

### DETAILED DESCRIPTION

The feed.

CO2 gas that has been separated from industrial flue gases can be converted into medium BTU product gas. Alternatively or additionally, the CO2 gas may be simultaneously injected into a reactor with a hydrocarbon gas and converted into an intermediate gas suitable for further processing of liquid fuel fuels.

Process Condition.

In at least one embodiment, the process may use a system comprising a layer of molten iron and a layer of reactive slag under high temperature reducing conditions to convert gas components into useful forms. The iron layer may be at a temperature within a range from about 2,500 degrees F. to about 2,900 degrees F., while the molten, reactive slag may be at a temperature of about 2,900 F. Measuring the temperature of the iron and the slag layers may be performed quantitatively (when the reactor design permits) or qualitatively. Suitable quantitative methods include physical and electrical methods, radiation emissions, and calculating temperatures from heat and/or mass balances. Quantitative measurements rely on exit gas composition readings. The qualitative method may require only routine experimentation to correlate the appropriate energy inputs with an acceptable output gas composition.

In the temperature range of about 2000 degrees F. to about 2500 degrees F., CO2 dissociates to carbon monoxide (CO) to form a clean, medium BTU gas having a calorific potential of about 240-320 BTU cu./ft. When CO2 and a hydrocarbon gas are simultaneously injected into the conversion reactor, the reactor may generate a hydrocarbon intermediate gas stream, suitable for synthesis of liquid fuels for further processing into low sulfur diesel fuel, gasoline, avionic fuel, or any other hydro-carbon product, according the Fisher-Tropsch Process.

In at least one embodiment, a reducing environment is maintained in the reactor. Maintaining a reducing environment involves controlling the C:O ratio inside the reactor at about 1 or higher. In at least one embodiment, the C:O ratio in the reactor is maintained at greater than 1.05. This C:O ratio may be maintained by adding one or more sources of carbon or oxygen. Maintaining a reducing environment may also involve the presence of a sufficient elemental carbon in the molten iron layer to act as a buffer against elemental carbon fluctuations in the incoming gas feed.

The C:O ratio may be controlled at the incoming gas feed of a reactor. The C:O ratio of the incoming gas feed can be monitored and controlled by a number of conventional methods. One method of controlling the C:O ratio is to use historical information about the gas source. For example, a source that has always produced a certain gas product distribution will probably continue to produce that distribution absent some form of change. Another method for controlling the C:O ratio is a conventional, automatic means for measuring physical properties of the gas composition at the inlet to the molten treatment reactor. Another method for controlling the C:O ratio is monitoring the output gas composition and adding carbon or oxygen sources to the system if unreduced gas components are detected. The carbon sources may be hydrocarbon gases, coal, coke, oil, and natural gas. The oxygen sources may be elemental oxygen, water vapor, and cellulosic materials. Gaseous sources of the carbon and oxygen may be used to minimize the loss of heat associated with changing phase in the molten metal. Other methods can be used and are readily identifiable to one skilled in the art.

The addition of carbon and/or oxygen can also be used as fuel sources for controlling the temperature of molten iron and slag layers in the reactor. Carbon sources may be injected into the system with the feed gas or added via an introduction port in the reactor above the uppermost layer. Oxygen sources may be added by similar methods and/or injected into the iron layer to react with the elemental carbon absorbed therein.

The iron layer in the reactor should be sufficiently thick (as measured in the vertical path of the rising gas) to produce a residence time of the gas in the iron layer of about 1-3 seconds. This period of time is adequate for the desired chemical conversion reactions to occur. Typical gas injection pressures may be between about 25-250 psig. In at least one embodiment, the gas injection pressures are between 25-75 psig. In addition, the iron layer should have a volume that is adequate to absorb sufficient carbon as a buffer for maintaining a C:O ratio of greater than 1. Because elemental carbon is absorbed up to about 4 wt. % in molten iron, the process may be operated at substantially this carbon saturation limit. However, lower levels of carbon absorption can also be used. A carbon source, such as coal or coke, can be added in minor quantities at the startup of the process to start the formation of a carbon buffer or from time-to-time if the carbon content exhibits signs of dropping below about 2 wt. %. Iron fillings may also be added from time-to-time to refresh the iron layer.

A reactive slag layer positioned above the iron layer may be a natural slag that is made reactive toward the incoming atomic pollutants by adding calcium oxide (lime) to achieve a base to acid ratio greater than about 1. In at least one embodiment, the base to acid ratio is above 2. In another embodiment, the base to acid ratio is within a range from about 3.5 to 5. The molar base to acid ratio of the slag may be calculated as (% CaO+% MgO)/(% SiO2+% Al2O3). Oxides can be added from time to time as a powder or as small chunks to maintain the desired base to acid ratio. For economic operation, it may be desirable to remove and readjust the composition when the base to acid ratio has fallen below about 2. Calcium fluoride may be added on the order of 2-10 wt. % to the initial slag as flux to reduce the viscosity of the slag. In at least one embodiment, calcium fluoride is added on the order of 5-10 wt. % to the initial slag. The added calcium oxide may bind sulfur from the iron into a stable complex in accord with equation 1 that, when cooled, may be safely stored in a landfill, used as a cement clinker, or used as a construction material.

FeS(iron)+CaO(slag)→CaS(slag)+FeO(slag) Equation 1:

The calcium oxide may interact with iron sulfide depending on both the carbon and the silicon content within the iron layer. For example, if the iron is saturated with carbon, the iron will transfer sulfur to the slag according to equation 2, thereby regenerating itself and forming CO.

FeS+CaO(slag)+C(iron)→CaS(slag)+Fe+CO Equation 2:

If the iron layer has both carbon and silicon dissolved therein, the CaO may regenerate iron while silicon may be oxidized according the equation 3.

2FeS+2CaO(slag)+Si(iron)→2CaS(slag)+Fe+SiO2(slag) Equation 3:

Reactor heating system.

In a reactor, the heat lost from the iron layer due to dissociation and reaction may reduce the temperature of the molten iron layer. One method of adding back the lost heat is by adding carbon sources and/or oxygen sources, as discussed above, that release heat upon reaction. These carbon and oxygen sources can also be the same sources used to control the C:O ratio within the reactor system.

Another method of adding heat to the system is with an electric arc (spark or plasma) or a gas burner located above the slag layer. The arc heating techniques may be those used in the technology of metal smelting. Additionally or alternatively, carbon or consumable metal electrodes may be used. The gas burners may be designed for high temperature reactors and may burn methane or natural gas.

A third method of adding heat to the system is induction. In the technique of heating via induction, a current may be passed through a coil surrounding the molten iron layer. The current may induce a flow of energy in the conductive metal layer and a magnetic field. The flow of energy may be resisted by the metal, thereby generating heat. The magnetic field may set up an intra-layer circulation pattern that promotes interlayer material transfer. The induction coil can be built into the reactor wall or may be positioned around the outside of the reactor over a discrete length of the reactor that will extend over the length of the molten metal layer.

Induction heating may be used alone or in combination with other heat sources. In at least one embodiment, induction heating is used as the primary energy source with added chemical agents for minor temperature modification. Induction heating may be faster than oxidizing fuel, may not require preheating like chemical fuel, and may not absorb activation energy from the system.

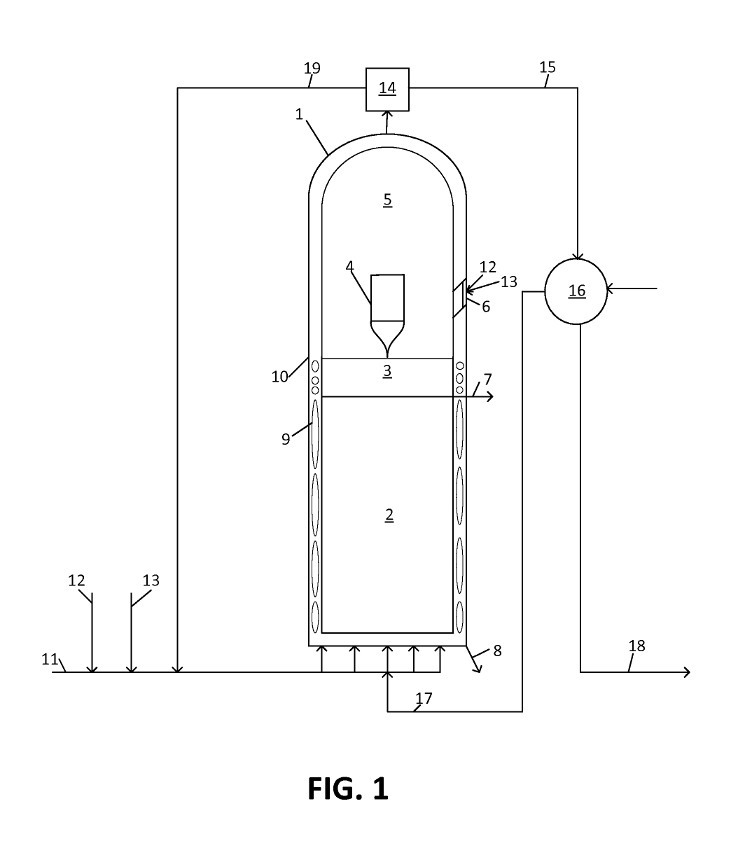

FIG. 1 illustrates an up-flow reactor 1 that may be used in accordance with aspects of this disclosure. The reactor 1 may contain a single molten iron layer 2 and a reactive slag layer 3 posited above the molten iron layer 2. The molten iron layer 2 may constitute about 80 vol. % of the combined total volume of molten iron layer 2 and slag layer 3. The reactor 1 may have a height-to-diameter ratio of about 3:1. However, the exact dimensions may depend on the gas feed rate. Electric arc 4 may be located above slag layer 3 in freeboard area 5. Freeboard area 5 may be at least about 50 vol. % of the total volume in reactor 1. Freeboard area 5 may be used for separating gas from slag layer 3. Freeboard area 5 may also include electric arc 4 and sampling port 6.

One or more materials (e.g. carbonaceous sources or slag flux) or probes may be introduced into reactor 1 through sampling port 6. Excess slag from slag layer 3 may be withdrawn from the reactor 1 through drainage port 7. Bottom drain 8 will permit reactor 1 to be drained quickly in the event of an accident or maintenance. Induction coils 9 may be arranged within the wall of reactor 1 to surround iron layer 2. Cooling coils 10 may be positioned around slag layer 3. These cooling coils 10 may contain a circulating gas or liquid, e.g. water. The circulation rate of the circulating gas or liquid may be controlled by appropriate control monitors and valves (not shown).

Incoming CO2 gas 11 may enter the reactor 1 below the iron layer 2 through a distribution means, e.g. a plurality of nozzles or tuyeres, a distribution plate, or other form of baffling. The pressure in the reactor 1 may be sufficient to overcome the hydrostatic force of the molten layers and allow the CO2 gas 11 to rise through the reactor 1. The incoming pressure in the reactor 1 may also be sufficient to prevent flow of the molten materials back through the distribution means. An appropriate anti-backflow valve or gate may be used for additional protection.

Oxygen source 12 and carbon source 13 can be introduced into freeboard area 5 or, preferably in fluid communication with incoming CO2 gas 11. The flow rate of oxygen source 12 and carbon source 13 may be controlled by appropriate composition and/or temperature sensors (not shown) to adjust for an oxygen lean stoichiometry within reactor 1 and to maintain effective temperatures within iron and slag layers. Steam 17 may be introduced into the reactor 1. Steam 17 may be produced by cooling treated gas 15 in heat exchanger or converter 16. Steam 17 may be a good source of both hydrogen and oxygen for producing a product gas 18 that is rich in carbon monoxide and hydrogen and suitable for synthesis of liquid fuels for further processing into low sulfur liquid fuel, gasoline, or any other hydrocarbon product, according to the Fisher-Tropsch Process. Steam 17 may also be used to cool the molten iron layer 2 when introduced to the incoming gases 11. Steam 17 may be used to achieve suitable conversion temperatures in the reactor 1.

A compositional analysis of treated gas 15 will indicate whether reducing conditions are present within the layer and whether inorganic material is being bound in slag layer 3. In the event that conditions are not within the desired parameters, e.g. a low C:O ratio or temperature, control system 14 will recycle the partially treated gas 19 for retreatment in the reactor 1 and activate or indicate appropriate oxygen, carbon, and/or energy inputs to the system to correct the conditions.

Variations and modifications of the foregoing are within the scope of the present disclosure. It should be understood that the inventions disclosed and defined herein extends to the individual features and all alternative combinations of two or more of the individual features mentioned or evident from the text and/or drawings. All of these different combinations constitute various alternative aspects of the present disclosure. The embodiments described herein explain the best modes known for practicing the inventions and will enable others skilled in the art to utilize the inventions.

1. A process for converting carbon dioxide (CO2) gas into a medium BTU carbon monoxide (CO) gas, comprising:
injecting CO2 gas upward and sequentially into a treatment reactor through superimposed layers of iron and a reactive slag,
wherein the reactive slag layer has a base to acid ratio of at least 1 and includes calcium fluoride, and
wherein the carbon to oxygen ratio in the treatment reactor is greater than 1.

2. The process according to claim 1 wherein the reactive slag layer has a base to acid ratio of at least 2.

3. The process of claim 2 wherein the reactive slag layer has a base to acid ratio within a range from 3.5 to 5.

4. The process of claim 1, further comprising:
adding heat to the treatment reactor.

5. The process of claim 4, wherein heat is added to the treatment reactor through one or more of an electric arc, a gas burner, induction heating, or the addition of carbon and oxygen.

6. The process of claim 1, wherein the residence time of the CO2 gas in the iron layer is between 1 and 3 seconds.

7. The process of claim 1, further comprising:
adding steam to the treatment reactor.

8. The process of claim 1, wherein the base to acid ratio of the reactive slag layer is obtained by adding calcium oxide to the reactive slag layer.

9. The process of claim 1, wherein the treatment reactor is configured to convert the CO2 gas into an intermediate gas stream, which is suitable for synthesis of liquid fuels for further processing into a hydrocarbon product, according to the Fischer-Tropsch process

10. A process for converting carbon dioxide (CO2) gas and hydrocarbon gas into a medium BTU gas comprising:
simultaneously injecting into a treatment reactor carbon dioxide (CO2) gas and a hydrocarbon gas including one or more of methane gas, natural gas, or gasification hydrocarbon gas,
wherein the CO2 gas and the hydrocarbon gas are injected upwardly and sequentially through superimposed layers of iron and a reactive slag,
wherein the reactive slag layer has a base to acid ratio of at least 1 and includes calcium fluoride, and
wherein the treatment reactor has a carbon to oxygen ratio of greater than 1 and is configured to convert the CO2 gas and hydrocarbon gas into an intermediate gas stream, which is suitable for synthesis of liquid fuels for further processing into a hydrocarbon product, according to the Fischer-Tropsch process.

11. The process of claim 10 wherein the reactive slag layer has a base to acid ratio of at least 2.

12. The process of claim 10 wherein the reactive slag layer has a base to acid ratio within a range from 3.5 to 5.

13. The process of claim 10, further comprising:
adding heat to the treatment reactor.

14. The process of claim 13, wherein heat is added to the treatment reactor through one or more of an electric arc, a gas burner, induction heating, or the addition of carbon and oxygen.

15. The process of claim 10, wherein the residence time of the CO2 gas and hydrocarbon gas in the iron layer is between 1 and 3 seconds.

16. The process of claim 10, further comprising:
adding steam to the treatment reactor.

17. The process of claim 10, wherein the base to acid ratio of the reactive slag layer is obtained by adding calcium oxide to the reactive slag layer.

18. A process for converting carbon dioxide (CO2) gas, which is separated from industrial flue gases, and hydrocarbon gas into a medium BTU gas comprising:
simultaneously injecting into a treatment reactor carbon dioxide (CO2) gas and a hydrocarbon gas including one or more of methane gas, natural gas, or gasification hydrocarbon gas,
wherein the CO2 gas and the hydrocarbon gas are injected upwardly and sequentially through superimposed layers of iron and a reactive slag,
wherein the iron layer has a carbon to oxygen ratio of greater than 1,
wherein the reactive slag layer has a base to acid ratio of at least 1 and includes calcium fluoride, and
wherein the treatment reactor has a carbon to oxygen ratio of greater than 1 and is configured to convert the CO2 gas and hydrocarbon gas into an intermediate gas stream, which is suitable for synthesis of liquid fuels for further processing into a hydrocarbon product, according to the Fischer-Tropsch process.

19. The process of claim 18, further comprising:
adding carbon to the treatment reactor by adding iron fillings.

20. The process of claim 18, wherein the CO2 gas and the hydrocarbon gas are injected into the iron layer at a pressure between 25 and 75 psig.
